(19) United States
(12) Patent Application Publication
(10) Pub. No.: US 2012/0019435 A1
(43) Pub. Date: Jan. 26, 2012

(54) INFORMATION TERMINAL APPARATUS, INFORMATION DISPLAY APPARATUS, AND WIRELESS NETWORK SYSTEM

(75) Inventors: Tatsuya HASHIMOTO, Osaka (JP); Norimitsu SUGIYAMA, Osaka (JP)

(73) Assignee: PANASONIC CORPORATION, Osaka (JP)

(21) Appl. No.: 13/037,340

(22) Filed: Feb. 28, 2011

(30) Foreign Application Priority Data
Jul. 22, 2010 (JP) 2010-164572

(51) Int. Cl. H04B 7/00; G09G 5/00

(52) U.S. Cl. 345/2.3; 455/41.2

(57) ABSTRACT

Provided is a wireless network system operable to exchange information, which is pertinent to a wireless connection, between an information terminal apparatus and an information display apparatus before the wireless connection is established and to present to a user a state of the wireless connection, which proceeds up until the wireless connection has been established. Before the wireless connection to the information terminal apparatus is established, the information display apparatus generates wireless network information, causes an SSID beacon to include the wireless network information, and transmits the SSID beacon. The information terminal apparatus causes an SSID beacon to include information to be displayed on a display device. The information display apparatus obtains the information from the SSID beacon and causes the display device to display the information.

### CROSS-REFERENCE TO RELATED APPLICATION

The disclosure of Japanese Patent Application No. 2010-164572, filed on Jul. 22, 2010, is incorporated herein by reference.

### BACKGROUND OF THE INVENTION

1. Field of the Invention

The present invention relates to a wireless network system which includes an information terminal apparatus and an information display apparatus which are connected via a wireless network and causes a display device to display a state of progress of connection processing of the information terminal apparatus via the information display apparatus before a wireless connection is established.

2. Description of the Background Art

In recent years, a wireless network has become widespread, and in many places such as offices and schools, networks (a wireless LAN, etc.) have been built. In addition, there have been an increase in opportunities such as conferences or the like, in which a presentation document is stored in an apparatus and, by utilizing the wireless network, is wirelessly transmitted to another apparatus different from the apparatus having the presentation document stored therein, and a presentation is performed. However, when attempts are made to establish a wireless connection between the above-mentioned apparatuses, communications may be restricted by pieces of software installed in the apparatuses for the purpose of enhancing security, and there is a likelihood that the wireless connection will fail.

There is disclosed a network connection diagnostic program (for example, Japanese Patent Application Laid-Open Publication No. 2004-234330 (hereinafter, referred to as patent document 1)) in which, when some failure regarding a wireless connection occurs and the wireless connection fails, the cause of the failure is inferred and a user is notified of a way of addressing the failure. In the network diagnostic program of the invention disclosed in patent document 1, when occurrence of a trouble regarding a network connection of each of a wired LAN device and a wireless LAN device is detected, a message indicating a location where the trouble has occurred and a countermeasure to address the trouble is displayed. Thus, a user is provided with a suggestion for solving a trouble regarding a network connection.

However, the above-mentioned conventional network connection diagnostic system has a problem in that the cause of failure resulting from software such as a firewall cannot be identified whereas the cause of connection failure resulting from information (turning-off of a wireless switch or the like) which can be obtained from a personal computer can be identified. In this case, all solutions to all items which are supposed to be causes of the connection failure have to be presented to a user, and a user is required to spend excessive time and labor to solve the connection failure. Moreover, a user cannot determine a state of progress at all until the connection has been established and therefore, the above-mentioned conventional network connection diagnostic system also has a problem in that a user feels uneasy about the state of progress of the connection.

### SUMMARY OF THE INVENTION

Therefore, to solve the above-mentioned problems, objects of the present invention are to provide an information terminal apparatus, an information display apparatus, and a wireless network system, each of which is operable to exchange information, which is pertinent to a wireless connection, between the information terminal apparatus and the information display apparatus before the wireless connection is established by using signals such as SSID beacons and the like, which can be recognized before the wireless connection is established, and operable to present to a user a state of the wireless connection, which proceeds up until the wireless connection has been established.

The present invention is directed to the information terminal apparatus operable to cause a display device to display information via the information display apparatus. In order to achieve one of the above-mentioned objects, the information terminal apparatus according to the present invention comprises: a first signal analysis part for receiving from the information display apparatus a signal including wireless network information, for analyzing the received signal, and for obtaining the wireless network information before a wireless connection to the information display apparatus is established, the wireless network information being used for establishing the wireless connection between the information display apparatus and the information terminal apparatus; a first signal generation part for generating a signal including the information to be displayed on the display device and for transmitting the signal to the information display apparatus; and a network connection part for issuing a wireless connection request to the information display apparatus by using the wireless network information.

In addition, the present invention is also directed to the information display apparatus operable to cause the display device to display information received from the information terminal apparatus. In order to achieve another of the above-mentioned objects, the information display apparatus according to the present invention comprises: a network generation part for generating wireless network information and for processing the wireless connection request issued from the information terminal apparatus before a wireless connection to the information terminal apparatus is established, the wireless network information being used for establishing the wireless connection between the information display apparatus and the information terminal apparatus; a second signal generation part for generating a signal including the wireless network information and for transmitting the signal to surroundings; a second signal analysis part for receiving a signal from the information terminal apparatus, for analyzing the received signal, and for obtaining the information to be displayed on the display device; and a display part for causing the display device to display the obtained information.

In addition, the present invention is also directed to the wireless network system in which the information terminal apparatus causes the display device to display the information via the information display apparatus, the wireless network system comprising the information terminal apparatus and the information display apparatus. In order to achieve the other of the above-mentioned objects, in the wireless network system according to the present invention, the information terminal apparatus includes: a first signal analysis part for receiving from the information display apparatus a signal including wireless network information, for analyzing the received signal, and for obtaining the wireless network information before a wireless connection to the information display apparatus is established, the wireless network information being used for establishing the wireless connection between the information display apparatus and the information terminal apparatus; a first signal generation part for generating a signal including the information to be displayed on the display device and for transmitting the signal to the information display apparatus; and a network connection part for issuing a wireless connection request to the information display apparatus by using the wireless network information. In addition, the information display apparatus includes: a network generation part for generating the wireless network information and for processing the wireless connection request issued from the information terminal apparatus before the wireless connection to the information terminal apparatus is established; a second signal generation part for generating a signal including the wireless network information and for transmitting the signal to surroundings; a second signal analysis part for receiving the signal from the information terminal apparatus, for analyzing the received signal, and for obtaining the information to be displayed on the display device; and a display part for causing the display device to display the obtained information.

In addition, the processing performed by the first signal analysis part, the first signal generation part, and the network connection part included in the above-described information terminal apparatus can be perceived also as a method implemented by the information terminal apparatus operable to cause the display device to display the information via the information display apparatus. The above-mentioned method comprises the steps of: receiving from the information display apparatus a signal including wireless network information used for establishing a wireless connection between the information display apparatus and the information terminal apparatus before the wireless connection to the information display apparatus is established; analyzing the received signal and obtaining the wireless network information; generating a signal including the information to be displayed on the display device and transmitting the signal to the information display apparatus; and issuing a wireless connection request to the information display apparatus by using the wireless network information.

In addition, the processing performed by the network generation part, the second signal generation part, the second signal analysis part, and the display part included in the above-described information display apparatus can be perceived also as a method implemented by the information display apparatus operable to cause the display device to display the information received from the information terminal apparatus. The above-mentioned method comprises the steps of: generating wireless network information used for establishing a wireless connection between the information display apparatus and the information terminal apparatus, before the wireless connection to the information terminal apparatus is established; generating a signal including the wireless network information and transmitting the signal to surroundings; receiving the signal from the information terminal apparatus; analyzing the signal received from the information terminal apparatus and obtaining the information to be displayed on the display device; causing the display device to display the obtained information; and processing a wireless connection request issued from the information terminal apparatus.

Preferably, each of the methods implemented by the information terminal apparatus and the information display apparatus is provided in the form of a program for causing a CPU to execute the series of procedures. This program may be stored in a non-transitory computer-readable storage medium.

As described above, the information terminal apparatus and the information display apparatus according to the present invention cause the signals such as the SSIDs and the like, which can be recognized before the wireless connection to the information display apparatus is established, to include the information pertinent to the wireless connection to the information display apparatus, thereby allowing a state of the connection processing to be displayed on the display device. This allows a user to determine the state of the wireless connection, which proceeds up until the wireless connection has been established. In addition, the information terminal apparatus transmits to the information display apparatus the signal such as the SSID, which includes the state of progress of the connection processing in a phased manner, thereby allowing a user to determine in the phased manner the state of progress, which proceeds up until the wireless connection has been established.

In addition, the information display apparatus analyzes the state of the connection processing, received from the information terminal apparatus, whereby when a connection failure is detected, it can be displayed on the display device that the connection has failed. This allows a user to immediately determine that the connection has failed. In addition, it is fed back from the information display apparatus to the information terminal apparatus that the connection has failed, whereby it can be determined on the information terminal apparatus in which phase of the connection processing the connection has failed. This makes identification of a cause of the connection failure easy, thereby allowing an appropriate solution to a trouble to be presented to a user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram illustrating a wireless network system according to an embodiment 1 of the present invention;

FIG. 2 is a block diagram illustrating one example of a configuration of an information terminal apparatus 100 and an information display apparatus 200 according to the embodiment 1 of the present invention;

FIG. 3 is a flowchart showing one example of operations of the information terminal apparatus 100 and the information display apparatus 200 according to the embodiment 1 of the present invention;

FIG. 4 is a flowchart showing one example of operations of an information terminal apparatus 100 and an information display apparatus 200 according to an embodiment 2 of the present invention;

FIG. 5 is a flowchart showing one example of operations of an information terminal apparatus 100 and an information display apparatus 200 according to an embodiment 3 of the present invention;

FIG. 6 is a block diagram illustrating one example of a configuration of an information terminal apparatus 100a and an information display apparatus 200 according to an embodiment 4 of the present invention;

FIG. 7A is a flowchart showing one example of operations of the information terminal apparatus 100a and the information display apparatus 200 according to the embodiment 4 of the present invention;

FIG. 7B is a flowchart showing another example of operations of the information terminal apparatus 100a and the information display apparatus 200 according to the embodiment 4 of the present invention;

FIG. 8 is a configuration diagram of a wireless network system according to an embodiment 5 of the present invention;

FIG. 9 is a flowchart showing one example of operations of the wireless network system according to the embodiment 5 of the present invention;

FIG. 10 is a configuration diagram of a wireless network system according to an embodiment 6 of the present invention; and

FIG. 11 is a flowchart showing one example of operations of the wireless network system according to the embodiment 6 of the present invention.

### DESCRIPTION OF THE PREFERRED EMBODIMENTS

Hereinafter, embodiments of the present invention will be described with reference to the accompanying drawings. In each of the present embodiments, the description will be given by using a personal computer as an information terminal apparatus and a projector as an information display apparatus. However, the present invention is not limited thereto. The information terminal apparatus may be any apparatus, instead of the personal computer, which is capable of wirelessly connecting to the information display apparatus. In addition, the information display apparatus may be any apparatus, instead of the projector, which is capable of wirelessly connecting to the information terminal apparatus and of displaying information on a display device.

### Embodiment 1

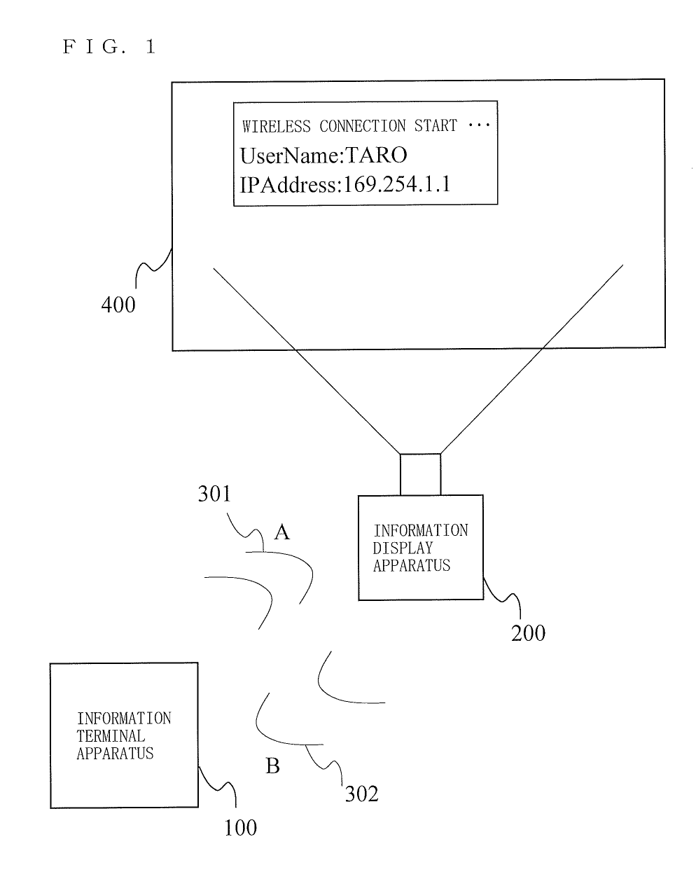

FIG. 1 is a configuration diagram illustrating a wireless network system according to an embodiment 1 of the present invention. In FIG. 1, an information terminal apparatus 100 typified by a personal computer and an information display apparatus 200 typified by a projector constitute the wireless network system. The information terminal apparatus 100 and the information display apparatus 200 are connected via a wireless network which a wireless LAN or the like constitutes. The information display apparatus 200 displays information on an externally located display device 400. The information display apparatus 200 may have the display device 400 built therein.

The information terminal apparatus 100 and the information display apparatus 200 conduct transmission and reception of a signal A301 and a signal B302 by using SSID beacons. The information terminal apparatus 100 and the information display apparatus 200 may conduct the transmission and reception of the signal A301 and the signal B302 by using signals other than the SSID beacons. For example, the information terminal apparatus 100 and the information display apparatus 200 may conduct the transmission and reception by using signals, instead of the SSID beacons, which can be recognized before a wireless connection is established and can include the signal A301 and the signal B302.

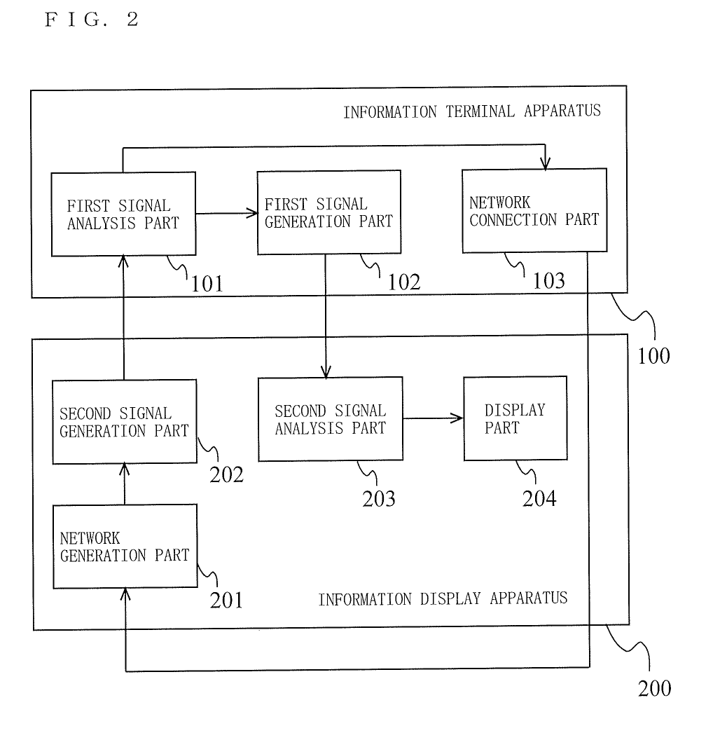

FIG. 2 is a block diagram illustrating one example of a configuration of the information terminal apparatus 100 and the information display apparatus 200 according to the embodiment 1 of the present invention. In FIG. 2, the information terminal apparatus 100 includes a first signal analysis part 101, a first signal generation part 102, and a network connection part 103. The first signal analysis part 101 analyzes the signal B302 included in the SSID beacon and obtains wireless network information generated by the information display apparatus 200. The wireless network information will be described later. Based on the information obtained by the first signal analysis part 101 and user information of the information terminal apparatus 100 (for example, information, such as a user name and address information, which allows a user of the information terminal apparatus 100 to be identified), the first signal generation part 102 generates the signal A301 including information to be displayed on the display device 400. The network connection part 103 issues a wireless connection request to the information display apparatus 200.

In FIG. 2, the information display apparatus 200 includes a network generation part 201, a second signal generation part 202, a second signal analysis part 203, and a display part 204. The network generation part 201 generates wireless network information typified by an SSID (Service Set Identifier) or the like. In addition, the network generation part 201 processes the wireless connection request issued by the information terminal apparatus 100. Based on the wireless network information generated by the network generation part 201 and information regarding the information display apparatus 200 (for example, an IP address of the information display apparatus 200 and the like), the second signal generation part 202 generates the signal B302. The second signal analysis part 203 analyzes the signal A301 generated by the information terminal apparatus 100. The display part 204 displays the information received from the information terminal apparatus 100 on the display device 400.

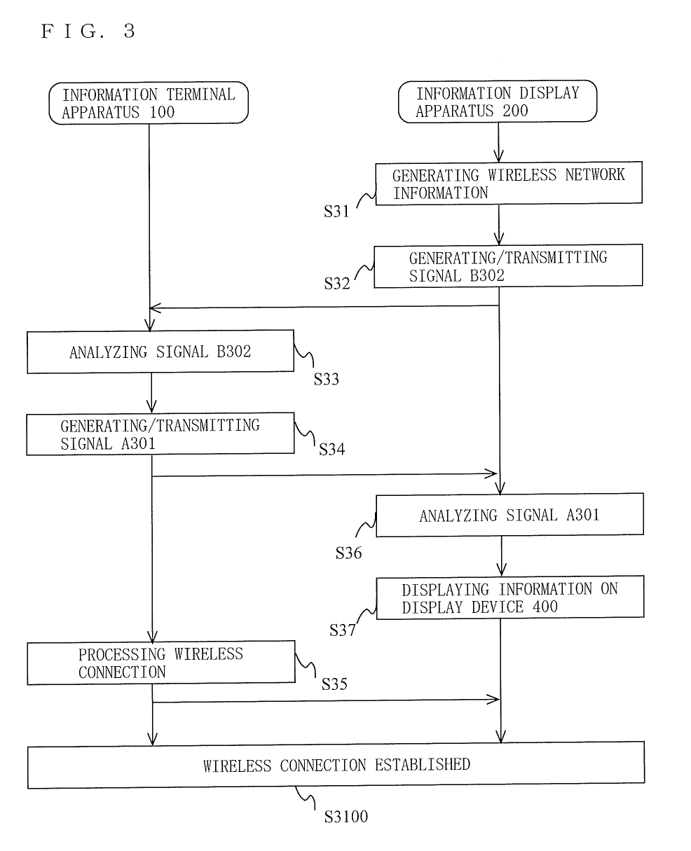

In the wireless network system, the information terminal apparatus 100 conducts the wireless connection to the information display apparatus 200 by using the wireless network information generated by the information display apparatus 200. In the present invention, before the wireless connection is established, the information display apparatus 200 displays the information received from the information terminal apparatus 100 on the display device 400. Operations of the information terminal apparatus 100 and the information display apparatus 200, performed at this time, will be described with reference to a flowchart shown in FIG. 3.

FIG. 3 is a flowchart showing one example of the operations of the information terminal apparatus 100 and the information display apparatus 200 according to the embodiment 1 of the present invention. In the information display apparatus 200, the network generation part 201 generates the wireless network information (step S31). The wireless network information generated here is used for establishing the wireless connection between the information terminal apparatus 100 and the information display apparatus 200, and in the present embodiment, the SSID is generated. Since up to 32 alphanumeric characters can be set in the SSID in an arbitrary manner, information can be included therein as a character string. Included in the SSID generated by the network generation part 201 are a unique identifier of the information display apparatus 200 (a unique ID, such as a serial number and a MAC address, which can be assigned to each apparatus), address information, wireless channel information, and the like in character strings. Moreover, in addition to the above-mentioned pieces of information, any information consisting of 32 characters or fewer can be included in the SSID.

The second signal generation part 202 generates a signal B302 including the SSID generated at step S31 and transmits the signal B302 to surroundings (step S32). It is required that the signal B302 be recognized by the information terminal apparatus 100 before the wireless connection between the information terminal apparatus 100 and the information display apparatus 200 is established. In the present embodiment, the SSID beacon is used as described above.

The information terminal apparatus 100 analyzes the signal B302 transmitted at step S32 by means of the first signal analysis part 101 and thereby obtains the information included in the SSID from the signal B302 (step S33). Here, the information included in the SSID is information included in character strings of the SSID, and in the present embodiment, the unique identifier, the address information, the wireless channel information, and the like of the information display apparatus 200 are included.

By using the signal A301 generated by the first signal generation part 102, the information terminal apparatus 100 transmits, to surroundings, the SSID which includes, as character string information, the unique identifier of the information display apparatus 200 and the information displayed on the display device 400 (step S34). In the present embodiment, as with the signal B302, the signal A301 is transmitted by using the SSDI beacon. As the information displayed on the display device 400, user information of the information terminal apparatus 100 (for example, information, such as a user name and address information, which allows a user of the information terminal apparatus 100 to be identified), transmission information (for example, progress information of a wireless connection), and the like are cited.

The information display apparatus 200 analyzes the signal A301 transmitted at step S34 by means of the second signal analysis part 203 and can thereby obtain the information included in the SSID from the signal A301 (step S36). In the present embodiment, when the unique identifier of the information display apparatus 200, which is one piece of information included in the character string information of the SSID, is the same as that of the information display apparatus 200, the information display apparatus 200 determines that the information is addressed to the information display apparatus 200 itself and passes the character string information of the SSID to the next step. When the unique identifier of the information display apparatus 200, which is one piece of information included in the character string information of the SSID, is different from that of the information display apparatus 200, the information display apparatus 200 determines that the information is not addressed to the information display apparatus 200 itself and abandons the character string information of the SSID.

By using the display part 204, the information display apparatus 200 displays on the display device 400 the character string information of the SSID obtained at step S36 (step S37).

Next, the network connection part 103 in the information terminal apparatus 100 issues a wireless connection processing request to the SSID obtained at step S33 (step S35). The information terminal apparatus 100 may start the wireless connection at step S35, prior to step S36 and step S37. However, because it takes time until such wireless connection is established, step S36 and step S37 are conducted in a preceding manner.

The information display apparatus 200 processes the wireless connection request from the information terminal apparatus 100. After a suitable period of time from the time when the wireless connection is started at step S35, when the wireless connection normally operates, the wireless connection between the information terminal apparatus 100 and the information display apparatus 200 is established (step S3100). In the present embodiment, the operations (that is, the operations at steps S31 through S34, step S36, and step S37) of the information terminal apparatus 100 and the information display apparatus 200, which are performed until the wireless connection processing request is issued, may be realized by using a communication method utilizing infrared rays or the like.

As described above, in the wireless network system according to the present embodiment, before the wireless connection between the information terminal apparatus 100 and the information display apparatus 200 is established, the information terminal apparatus 100 transmits the specific information (for example, the user information of the information terminal apparatus 100 and the like) to the information display apparatus 200, and the information can be displayed on the display device 400.

### Embodiment 2

The invention according to an embodiment 2 of the present invention is different from the invention according to the embodiment 1 in that a state of progress of connection processing performed by an information terminal apparatus 100 can be displayed in a phased manner on a display device 400 via an information display apparatus 200. Since configurations of the information terminal apparatus 100 and the information display apparatus 200 according to the embodiment 2 are the same as those according to the embodiment 1, a reference is made to FIG. 2 and the descriptions thereof will be omitted. Hereinafter, operations of the information terminal apparatus 100 and the information display apparatus 200 according to the embodiment 2 will be described, with the description focusing on differences from the embodiment 1.

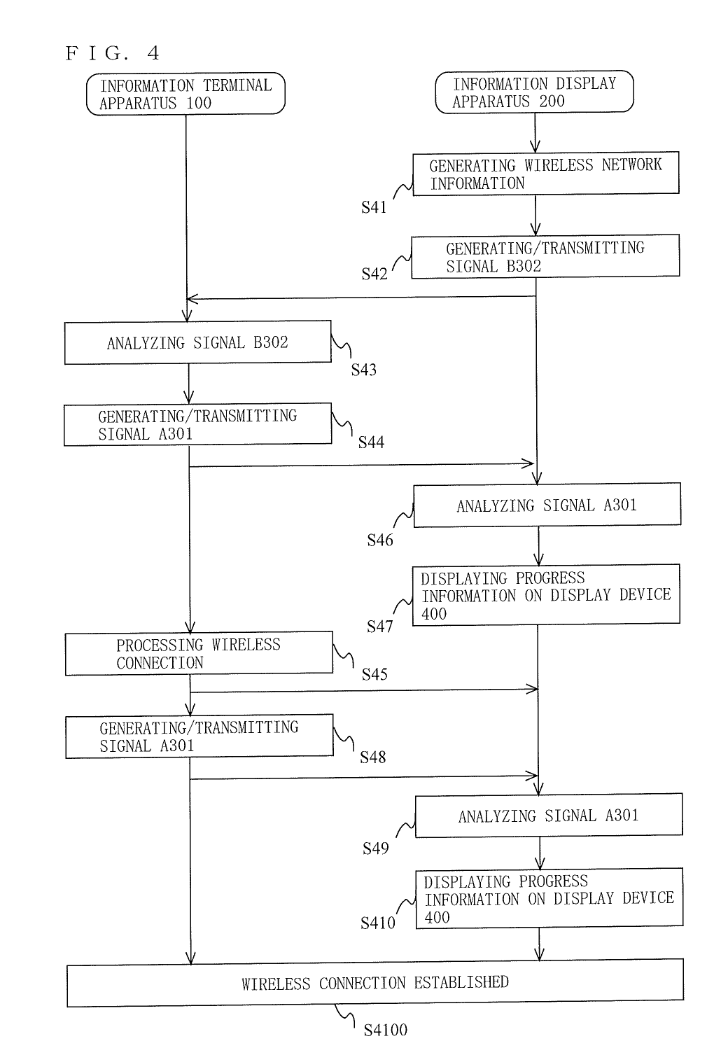

FIG. 4 is a flowchart showing one example of operations of the information terminal apparatus 100 and the information display apparatus 200 according to the embodiment 2 of the present invention. In FIG. 4, since operations at steps S41, S42, and S43 are the same as the operations at steps S31, S32, and S33 in the embodiment 1, the descriptions thereof will be omitted.

At step S44, the information terminal apparatus 100 transmits, to surroundings, an SSID, which includes as character string information a unique identifier of the information display apparatus 200 as information obtained at step S43, user information of the information terminal apparatus 100, and a current state of progress of a wireless connection of the information terminal apparatus 100 as transmission information, by using a signal A301 generated by a first signal generation part 102. Here, it is supposed that the state of progress of the wireless connection of the information terminal apparatus 100 is “wireless connection start”.

By analyzing the signal A301 transmitted at step S44 by means of a second signal analysis part 203, the information display apparatus 200 obtains, from the SSID included in the signal A301, the state of progress “wireless connection start” of the wireless connection of the information terminal apparatus 100 and the user information of the information terminal apparatus 100 (step S46). Also here, as with the embodiment 1, the information display apparatus 200 determines whether the unique identifier of the information display apparatus 200, which is one piece of information included in the character string information of the SSID, is information addressed to the information display apparatus 200 itself and determines whether the information is passed to the next step or is abandoned. When the unique identifier is different from that of the information display apparatus 200, the information display apparatus 200 determines that the information is not addressed to the information display apparatus 200 itself and abandons the character string information of the SSID.

The information display apparatus 200 relates the state of progress “wireless connection start” of the wireless connection of the information terminal apparatus 100, obtained at step S46, to the user information of the information terminal apparatus 100 and displays the state of progress “wireless connection start” thereof on a display device 400 via a display part 204 (step S47).

Next, the network connection part 103 in the information terminal apparatus 100 issues a wireless connection processing request to the SSID obtained at step S43 (step S45). In the wireless connection processing, the information terminal apparatus 100 communicates with the information display apparatus 200 first at a physical layer level and next at an IP level. In a phase at step S48, it is supposed that the information terminal apparatus 100 is in a phase in which setting of IP address information is started. At this time, a state of progress of the wireless connection of the information terminal apparatus 100 can be set to be “IP address information setting start”.

As with the processing at step S44, the information terminal apparatus 100 transmits, to surroundings, an SSID which includes as character string information a unique identifier of the information display apparatus 200, user information of the information terminal apparatus 100, and a current state of progress of the wireless connection of the information terminal apparatus 100 as transmission information, by using a signal A301 generated by the first signal generation part 102 (step S48). Here, it is supposed that the state of progress of the wireless connection of the information terminal apparatus 100 is “IP address information setting start”.

By analyzing the signal A301 transmitted at step S48 by means of the second signal analysis part 203, the information display apparatus 200 can obtain, from the SSID included in the signal A301, the state of progress “IP address information setting start” of the wireless connection of the information terminal apparatus 100 and the user information of the information terminal apparatus 100 (step S49). Also here, as with the embodiment 1, the information display apparatus 200 determines whether the unique identifier of the information display apparatus 200, which is one piece of information included in the character string information of the SSID, is information addressed to the information display apparatus 200 itself and determines whether the information is passed to the next step or is abandoned.

The information display apparatus 200 relates the state of progress “IP address information setting start” of the wireless connection of the information terminal apparatus 100, obtained at step S49, to the user information of the information terminal apparatus 100 and displays the state of progress “IP address information setting start” thereof on the display device 400 via the display part 204 (step S410).

After a predetermined period of time from the time when the wireless connection is started at step S45, when the wireless connection normally operates, the wireless connection between the information terminal apparatus 100 and the information display apparatus 200 is established (step S4100).

As described above, in the wireless network system according to the present embodiment, the current state of progress of the wireless connection of the information terminal apparatus 100 is included in the character string information of the SSID included in the signal A301 generated by the information terminal apparatus 100, whereby the state of progress of the wireless connection can be displayed on the display device 400 via the display part 204 of the information display apparatus 200.

In addition, in the present embodiment, the two phases of the current state of progress of the wireless connection of the information terminal apparatus 100, included in the character string information of the SSID, that is, “wireless connection start” and “IP address information setting start”, are adopted. However, increasing the number of phases makes it possible to display a further detailed state of progress of the wireless connection in a phased manner.

### Embodiment 3

The present invention according to an embodiment 3 is different from the embodiments 1 and 2 in that when a wireless connection has failed, it is displayed on a display device 400 that the wireless connection has failed. Since configurations of an information terminal apparatus 100 and an information display apparatus 200 according to the embodiment 3 are the same as those according to the embodiment 1, a reference is made to FIG. 2 and the descriptions thereof will be omitted. Hereinafter, operations of the information terminal apparatus 100 and the information display apparatus 200 according to the embodiment 3 will be described, with the description focusing on differences from the embodiments 1 and 2.

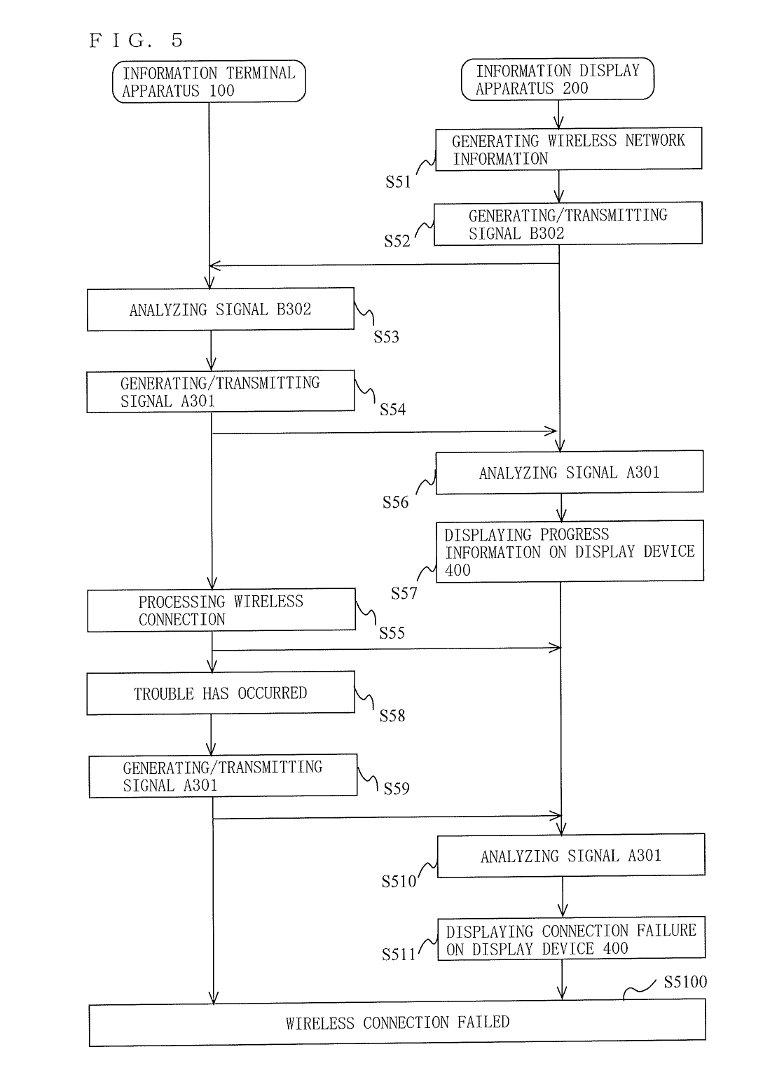

FIG. 5 is a flowchart showing one example of operations of the information terminal apparatus 100 and the information display apparatus 200 according to the embodiment 3 of the present invention. In FIG. 5, since operations at steps S51, S52, S53, S54, S55, S56, and S57 are the same as the operations at steps S41, S42, S43, S44, S45, S46, and S47 in the embodiment 2, the descriptions thereof will be omitted.

At step S58, it is supposed that some trouble has occurred in wireless connection processing. Because of the trouble having occurred at step S58, the information terminal apparatus 100 cannot start setting of IP address information, and a state of progress of a wireless connection of the information terminal apparatus 100 remains to be “wireless connection start”. Therefore, a state of progress of a wireless connection, which is included in character string information of an SSID included in a regularly transmitted SSID beacon, remains to be “wireless connection start” for a long period of time. Accordingly, at step S59, the information terminal apparatus 100 causes a signal A301 to include the state of progress of the wireless connection “wireless connection start”, which is the same as that at step S54, and transmits the signal A301.

By analyzing the signal A301 transmitted at step S59 by means of a second signal analysis part 203, the information display apparatus 200 can obtain, from the SSID included in the signal A301, the state of progress of the wireless connection of the information terminal apparatus 100 “wireless connection start” and user information of the information terminal apparatus 100 (step S510).

When the state of progress of the wireless connection of the information terminal apparatus 100 “wireless connection start”, obtained at step S510, does not change for a predetermined period of time, the information display apparatus 200 determines that the wireless connection has failed, relates information “connection failed in wireless connection start” to the user information of the information terminal apparatus 100, and displays the information “connection failed in wireless connection start” on a display part 204 (step S511). Thereafter, due to the failed wireless connection, the information terminal apparatus 100 and the information display apparatus 200 finish the processing (step S5100).

As described above, in the wireless network system according to the present embodiment, when the state of progress of the wireless connection in the character string information of the SSID included in the signal A301 generated by the information terminal apparatus 100 does not change for a long period of time (predetermined period of time), it is determined that the wireless connection has failed and it can be displayed on a display device 400 via the display part 204 of the information display apparatus 200 that the connection has failed.

Furthermore, in the present embodiment, when the state of progress of the wireless connection does not change for the predetermined period of time, it is determined that the connection has failed. However, when the information terminal apparatus 100 can determine that the connection has failed, through causing the signal A301 to include the state of progress of the wireless connection “connection failed in wireless connection start”, which is included in the character string of the SSID, and transmitting the signal A301, it also can be displayed on the display device 400 via the display part 204 of the information display apparatus 200 that the connection has failed.

### Embodiment 4

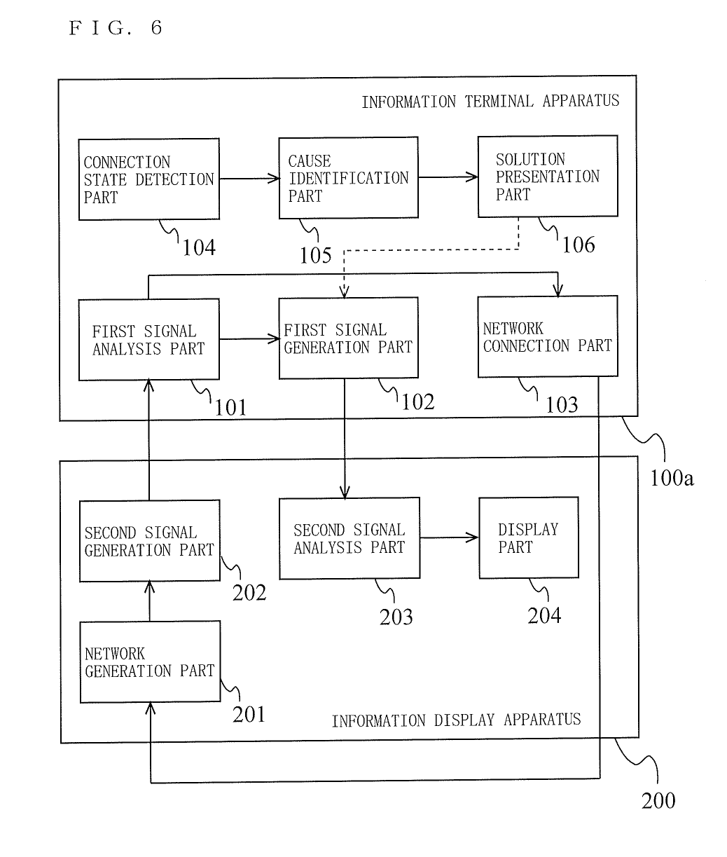

The invention according to an embodiment 4 of the present invention is different from the embodiment 3 in that a solution to a cause of a failure of a connection is presented to a user. FIG. 6 is a block diagram illustrating one example of a configuration of an information terminal apparatus 100a and an information display apparatus 200 according to the embodiment 4 of the present invention. In FIG. 6, the information terminal apparatus 100a includes a first signal analysis part 101, a first signal generation part 102, a network connection part 103, a connection state detection part 104, a cause identification part 105, and a solution presentation part 106. In the information terminal apparatus 100a according to the embodiment 4, since operations of the first signal analysis part 101, the first signal generation part 102, and the network connection part 103 are the same as those in the embodiments 1 through 3, the descriptions thereof will be omitted. In addition, since the configuration of the information display apparatus 200 according to the embodiment 4 is the same as that in the embodiments 1 through 3, the description thereof will be omitted.

In the information terminal apparatus 100a, the connection state detection part 104 detects a failure of the wireless connection from a display device 400 by using any inputting means. Based on information obtained from the connection state detection part 104, the cause identification part 105 identifies a cause of the failure of the connection. The solution presentation part 106 presents to a user a solution to the cause of the failure of the connection, which is identified by the cause identification part 105.

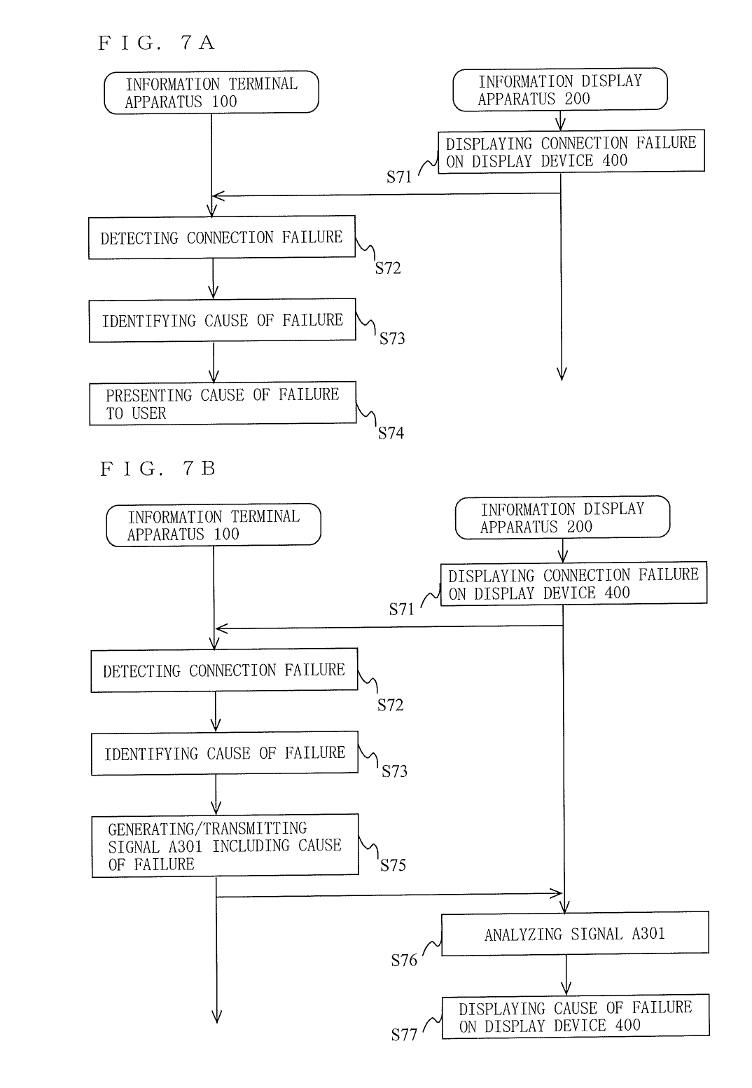

Regarding a wireless network system structured as described above, in the present embodiment, when “connection failed in wireless connection start” is displayed on the display device 400, operations performed until a solution to the cause of the failure of the connection is presented to a user will be described below with reference to a flowchart shown in FIG. 7A. FIG. 7A is a flowchart showing one example of operations of the information terminal apparatus 100a and the information display apparatus 200 according to the embodiment 4 of the present invention. In FIG. 7A, since operations performed until the wireless connection has failed are the same as those in the embodiment 3, the descriptions thereof will be omitted.

With reference to FIG. 7A, the information display apparatus 200 displays a character string “connection failed in wireless connection start” on a display device 400 (step S71). At this time, in accordance with a phase in which the connection has failed, the information display apparatus 200 may change a color or a display position of the character string displayed on the display device 400.

Next, in the information terminal apparatus 100a, the connection state detection part 104 detects from the information displayed on the display device 400 that the connection has failed, by using any inputting means (step S72). Here, as any inputting means, a method in which a user presses down each of the buttons of the information terminal apparatus 100a, which corresponds to each piece of the information displayed on the display device 400; a method in which the information terminal apparatus 100a is provided with an imaging element such as a camera, the information displayed on the display device 400 is shot therewith, and characters and colors are analyzed; and the like are cited. Here, in the connection state detection part 104, each color and each position of each of the buttons of the information terminal apparatus 100a are caused to correspond to each color and each position on a screen of each character string displayed on the display device 400, thereby allowing a user to easily determine which button corresponds to which information displayed on the display device 400.

Based on the information obtained from the connection state detection part 104, the information terminal apparatus 100a identifies a cause of the failure of the connection by means of the cause identification part 105 (step S73). Here, when the cause identification part 105 can determine, by means of the connection state detection part 104, a phase in connection processing, in which the connection has failed, it is made possible to easily identify a cause of the failure of the connection. For example, in the present embodiment, because the character string displayed on the display device 400 is “connection failed in wireless connection start”, the cause identification part 105 can determine that the connection has failed in the phase of the wireless connection start in the connection processing. Accordingly, by investigating only an item(s) for which setting is conducted in the phase of the wireless connection start, the cause identification part 105 can identify the cause of the failure of the connection.

The information terminal apparatus 100a obtains the cause of the failure of the connection identified by the cause identification part 105 and presents to a user a solution to the cause of the failure of the connection by means of the solution presentation part 106 (step S74). Here, as a method of finding a solution from the cause of the failure of the connection, a method in which a database or the like is consulted and a solution to the same cause of the failure of the connection is used is cited. For example, in the present embodiment, because “connection failed in wireless connection start” is shown, the solution presentation part 106 searches the database for a similar case in which the connection failed in the same phase in the connection processing in the past, whereby only the solution regarding the item for which the setting is conducted in the phase of the wireless connection start can be presented to a user.

By displaying a solution on, for example, a display (not shown) which the information terminal apparatus 100a has, the solution presentation part 106 can present the solution to a user. In addition, the solution presentation part 106 may present a solution to a user with a voice at the same time when the solution is displayed on the display, and the solution presentation part 106 may present a solution to a user with a voice alone.

In addition, as shown in FIG. 7B, the information terminal apparatus 100a may present a solution on the display device 400 via the information display apparatus 200. With reference to FIG. 7B, the solution presentation part 106 notifies the first signal generation part 102 of a solution to a cause of the failure of the connection. The first signal generation part 102 generates a signal A301 which is caused to include the solution in character string information of an SSID included in an SSID beacon and transmits the signal A301 to surroundings (step S75).

By analyzing the signal A301 transmitted at step S75 by means of a second signal analysis part 203, the information display apparatus 200 obtains the solution to the cause of the failure of the wireless connection from the SSID included in the signal A301 (step S76). The information display apparatus 200 relates the solution to the cause of the failure of the wireless connection, obtained at step S76, to user information of the information terminal apparatus 100a and displays the solution on the display device 400 via the display part 204 (step S77).

As described above, in the wireless network system according to the present embodiment, a phase in the connection processing in which the wireless connection has failed is determined, thereby allowing a solution to a cause of the failure of the connection to be accurately presented to a user.

### Embodiment 5

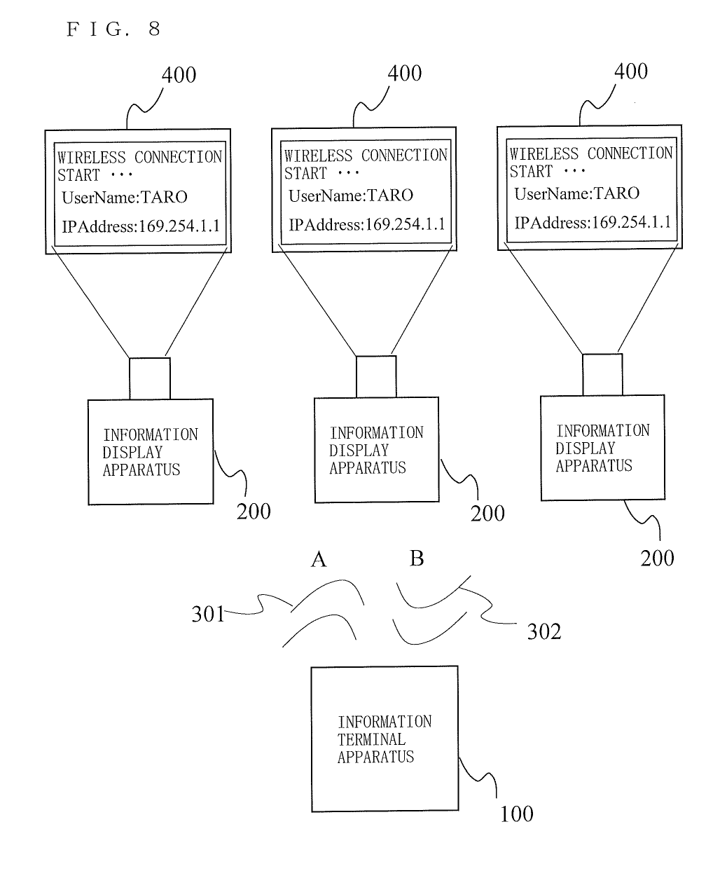

The invention according to an embodiment 5 of the present invention is different from the embodiments 1 through 4 in that a state of progress of connection processing of an information terminal apparatus 100 can be displayed on a multiple of the display devices 400 via a multiple of the information display apparatuses 200. FIG. 8 is a configuration diagram of a wireless network system according to the embodiment 5 of the present invention. In FIG. 8, the information terminal apparatus 100, which is typified by a personal computer, and the multiple information display apparatuses 200, each of which is typified by a projector, constitute a wireless network system. The multiple information display apparatuses 200 display information on the multiple externally located display devices 400. Since configurations of the information terminal apparatus 100 and each of the information display apparatuses 200 are the same as those in the embodiments 1 through 4, the descriptions thereof will be omitted.

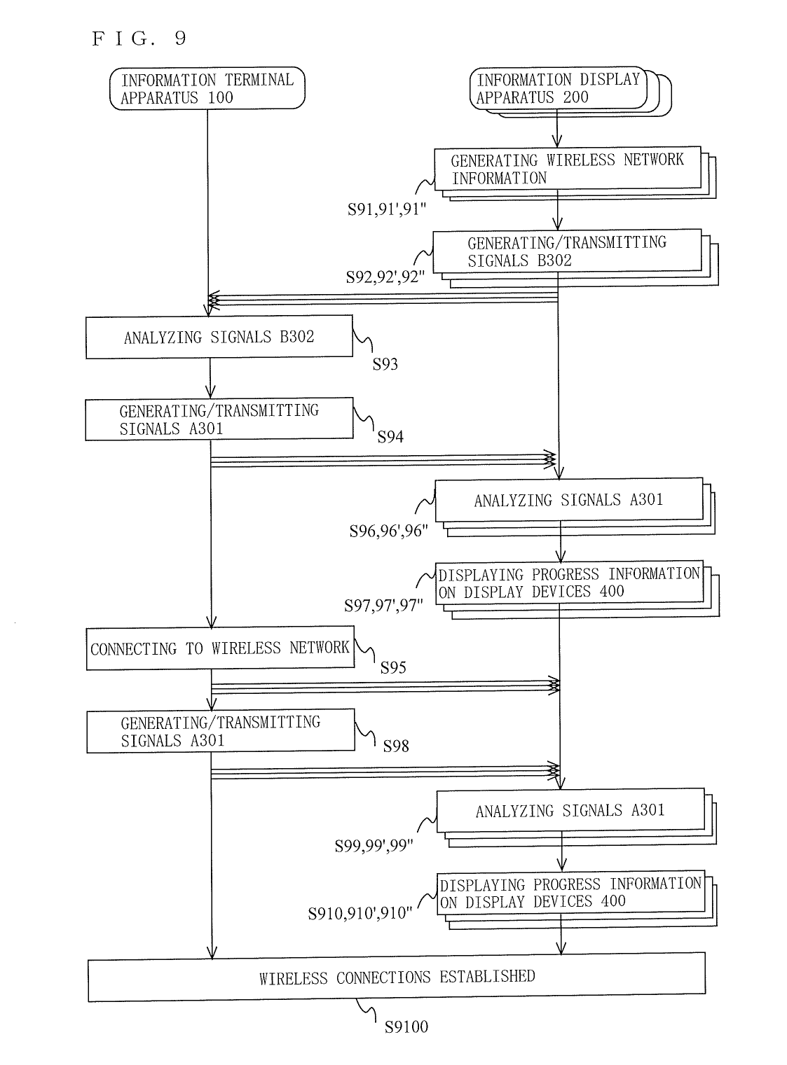

In the wireless network system, the information terminal apparatus 100 conducts the wireless connection to the wireless network information generated by the information display apparatuses 200. In the present invention, before a wireless connection is established, each of the multiple information display apparatuses 200 displays a state of progress of a wireless connection of the information terminal apparatus 100 on each of the multiple display devices 400. Operations of the information terminal apparatus 100 and the multiple information display apparatuses 200, performed at this time, will be described with reference to a flowchart shown in FIG. 9.

FIG. 9 is a flowchart showing one example of the operations of the wireless network system according to the embodiment 5 of the present invention. In each of the multiple information display apparatuses 200, a network generation part 201 generates wireless network information (steps S91, 91′, 91″). In the present embodiment, the wireless network information generated here is an SSID, and SSIDs, the number of which corresponds to the number of the information display apparatuses 200, are present.

The second signal generation part 202 generates signals B302 including the SSIDs generated at steps S91, 91′, 91″, and transmits the signals B302 to surroundings (steps S92, 92′, 92″). In the present embodiment, as each of the signals B302, an SSID beacon is used, and the signals B302, the number of which corresponds to the number of the information display apparatuses 200, are present.

By analyzing each of the signals B302 transmitted at steps S92, 92′, 92″ by means of a first signal analysis part 101, the information terminal apparatus 100 can obtain information included in each of the SSIDs from each of the signals B302 (step S93). Here, the information included in each of the SSIDs is information included in a character string of each of the SSIDs, and in the present embodiment, this information includes unique identifiers, address information, wireless channel information, and the like, the number of which each corresponds to the number of the information display apparatuses 200.

By using signals A301 generated by a first signal generation part 102, the information terminal apparatus 100 transmits, to surroundings, the SSIDs which include as character string information the unique identifiers being the information obtained at step S93, the number of which corresponds to the number of the information display apparatuses 200; user information of the information terminal apparatus 100; and transmission information (a state of progress of a wireless connection of the information terminal apparatus 100) (step S94). Since the information which each of the SSIDs can include consists of up to 32 characters, in a case where the number of the information display apparatuses 200, each of which displays a state of progress, is large, there may be a case where the SSIDs cannot include the unique identifiers, the number of which corresponds to the number of the information display apparatuses 200. In such a case, it is considered as a countermeasure that the information terminal apparatus 100 transmits different SSIDs, in which the user information and the transmission information are not changed and the unique identifiers of the information display apparatuses 200 alone are changed, by using the signals A301.

By analyzing the signals A301 transmitted at step S94 by means of second signal analysis parts 203, the multiple information display apparatuses 200 can obtain the information included in the SSIDs from the signals A301 (steps S96, 96′, 96″). In the present embodiment, when among the analyzed unique identifiers of the multiple information display apparatuses 200, which are included in the character string information of the SSIDs, each information display apparatus 200 finds the same unique identifier as its own unique identifier, the information display apparatus 200 determines that the information is addressed to the information display apparatus 200 itself and passes the character string information of the SSID to the next step. When among the analyzed unique identifiers of the multiple information display apparatuses 200, which are included in the character string information of the SSIDs, each information display apparatus 200 does not find the same unique identifier as its own unique identifier, the information display apparatus 200 determines that the information is not addressed to the information display apparatus 200 itself and abandons the character string information of the SSIDs.

Each of the information display apparatuses 200 displays character string information of each of the SSIDs obtained at steps S96, 96′, 96″ on each of the display devices 400 via a display part 204 (steps S97, 97′, 97″). Since a process conducted at step S98 is the same as that conducted at step S94 and processes conducted at steps S99, 99′, 99″ and steps S910, 910′, 910″ are the same as those conducted at steps S96, 96′, 96″ and steps S97, 97′, 97″, the descriptions thereof will be omitted.

After a predetermined period of time from the time when the wireless connection is started at step S95, when the wireless connection normally operates, the wireless connection between the information terminal apparatus 100 and the multiple information display apparatuses 200 is established (step S9100).

As described above, before the wireless connection is established between the information terminal apparatus 100 and the multiple information display apparatuses 200, the wireless network system according to the present embodiment can display a state of progress of the wireless connection on the multiple display devices 400, which corresponds to the multiple information display apparatuses 200, in a phased manner.

### Embodiment 6

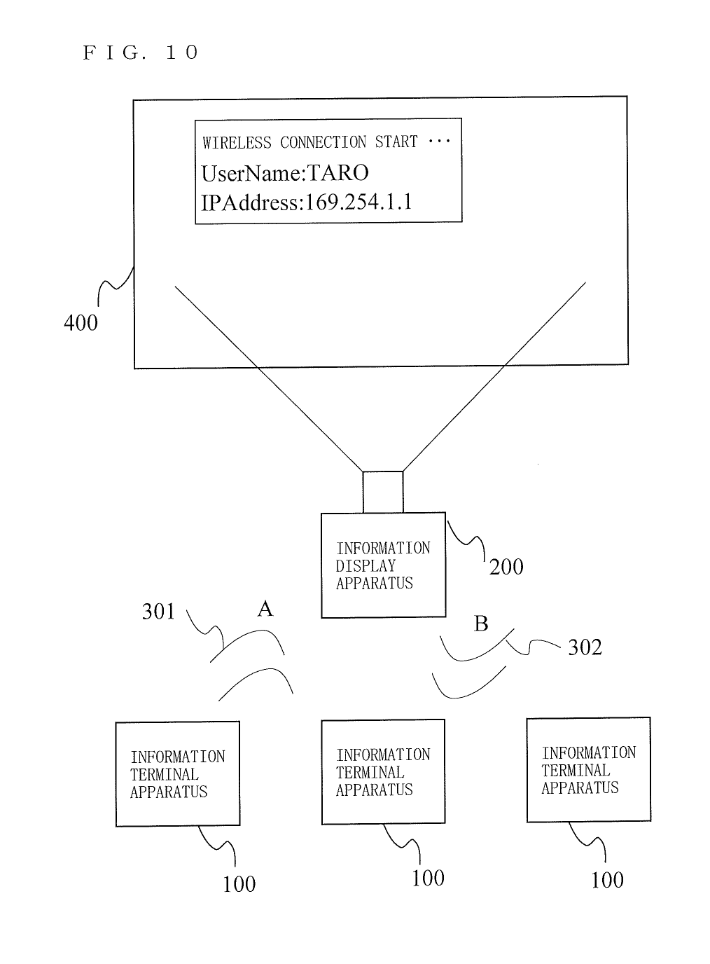

The invention according to an embodiment 6 of the present invention is different from the embodiments 1 through 4 in that states of progress of connection processing of a multiple of the information terminal apparatuses 100 are displayed on a display device 400 via one information display apparatus 200. FIG. 10 is a configuration diagram of a wireless network system according to the embodiment 6 of the present invention. In FIG. 10, the multiple information terminal apparatuses 100, each of which is typified by a personal computer, and one information display apparatus 200 which is typified by a projector constitute the wireless network system. The information display apparatus 200 displays information on the externally located display device 400. Since configurations of each of the information terminal apparatuses 100 and the information display apparatus 200 are the same as those in the embodiments 1 through 4, the descriptions thereof will be omitted.

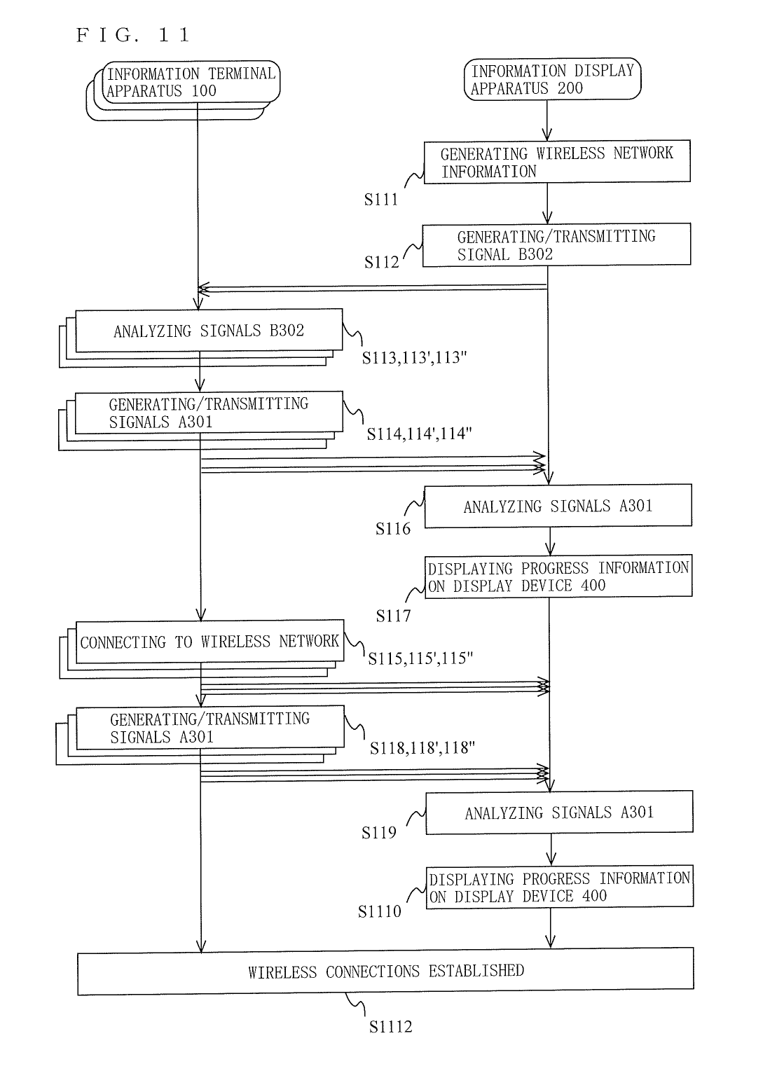

In the wireless network system, the multiple information terminal apparatuses 100 conduct the wireless connections to the wireless network generated by the information display apparatus 200. In the present invention, before the wireless connections are established, the states of progress of the wireless connections of the multiple information terminal apparatuses 100 are displayed on the display device 400 by using one information display apparatus 200. Operations of the multiple information terminal apparatuses 100 and the information display apparatus 200, performed at this time, will be described with reference to a flowchart shown in FIG. 11.

FIG. 11 is a flowchart showing one example of the operations of the wireless network system according to the embodiment 6 of the present invention. In the information display apparatus 200, a network generation part 201 generates the wireless network information (step S111). In the present embodiment, the wireless network information generated here is an SSID.

The second signal generation part 202 generates a signal B302 including the SSID generated at step S111 and transmits the signal B302 to surroundings (step S112). In the present embodiment, as the signal B302 generated here, an SSID beacon is used.

By analyzing the signal B302 transmitted at step S112 by means of a first signal analysis part 101, the multiple information terminal apparatuses 100 obtains information included in the SSID from the signal B302 (steps S113, S113′, S113″). Here, the information included in the SSID is information included in a character string of the SSID.

The multiple of information terminal apparatuses 100 transmits, to surroundings, the SSIDs, each of which includes, as character string information, a unique identifier of the information display apparatus 200, user information of each of the information terminal apparatuses 100, transmission information (the state of progress of the wireless connection of each of the information terminal apparatuses 100), which are included in the information obtained at steps S113, S113′, S113″, by using signals A301 generated by a first signal generation part 102 (steps S114, S114′, S114″).

By analyzing the signals A301 transmitted from the multiple of information terminal apparatuses 100 at steps S114, S114′, S114″ by means of a second signal analysis part 203, the information display apparatus 200 obtains the information included in the SSIDs from the signals A301 (step S116). The information display apparatus 200 determines whether the unique identifier of the information display apparatus 200, which is one piece of information included in the character string information of each of the SSIDs, is information addressed to the information display apparatus 200 itself and determines whether the information is passed to the next step or is abandoned. When the unique identifier is different from that of the information display apparatus 200, the information display apparatus 200 determines that the information is not addressed to the information display apparatus 200 itself and abandons the character string information of each of the SSIDs. In the present embodiment, since the signals A301, the number of which corresponds to the number of the information terminal apparatuses 100, are analyzed, user information, the number of which corresponds to the number of the information terminal apparatuses 100, and transmission information, the number of which corresponds to the number of the information terminal apparatuses 100, can be obtained.

The information display apparatus 200 displays character string information of the SSIDs obtained at step S116, the number of which corresponds to the number of the information terminal apparatuses 100 on the display device 400 via a display part 204 (step S117). Since processes conducted at steps S118, S118′, 5118″ are the same as those conducted at steps S114, S114′, S114″ and processes conducted at step S119 and step S1110 are the same as those conducted at step S116 and step S117, the descriptions thereof will be omitted.

As described above, the wireless network system according to the present embodiment can display the states of progress of the wireless connections of the multiple information terminal apparatuses 100 on the display device 400 via the display part 204 of the information display apparatus 200.

The procedures performed by the information terminal apparatus 100 and the information display apparatus 200 described in each of the embodiments of the present invention may be realized such that predetermined program data which is stored in a storage device (a ROM, a RAM, a hard disk, etc.) and allows execution of the above-mentioned procedures is interpreted and executed by a CPU. In this case, the program data may be loaded in the storage device via a storage medium or may be executed directly from the storage medium. Here, as the storage medium, a semiconductor memory such as a ROM, a RAM, and a flash memory, a magnetic disk memory such as a flexible disk and a hard disk, an optical disk memory such as a CD-ROM, DVD, and a BD, a memory card, and the like are included. In addition, the storage medium is a concept which includes a communication medium such as a telephone line and a carrying path.

In addition, in each of the embodiments of the present invention, functional blocks constituting the information terminal apparatus 100 and the information display apparatus 200 are realized typically by programs, each of which runs on a CPU (or a processor). However, a part or all of the functions may be realized as an LSI, which is an integrated circuit. Such an LSI may be individually constructed in a chip form, or one chip may include a part or all of the functions. Although the integrated circuit may be referred to as an LSI here, the integrated circuit may also be referred to as an IC, a system LSI, a super LSI, or an ultra LSI, depending on the degree of integration.

Also, the method of integration in the embodiments is not limited to the LSI, and may be realized by a dedicated circuit or a general purpose processor. Also, an FPGA (Field Programmable Gate Array), which is an LSI that can be programmed after manufacture, or a reconfigurable processor enabling connections and settings of the circuit cells in the LSI to be reconfigured may be used.

Further, in a case where other integration technology replacing the LSI becomes available due to improvement of a semiconductor technology or due to emergence of other technology derived therefrom, the integration of the functional blocks may be conducted by using such a new integration technology. For example, biotechnology may be applied to the above-mentioned integration.

The present invention is useful in displaying on a display device a state of progress or the like of a wireless connection between an information terminal apparatus and an information display apparatus typified by a projector or the like.

While the invention has been described in detail, the foregoing description is in all aspects illustrative and not restrictive. It will be understood that numerous other modifications and variations can be devised without departing from the scope of the invention.

What is claimed is:

1. An information terminal apparatus operable to cause a display device to display information via an information display apparatus, the information terminal apparatus comprising:
a first signal analysis part for receiving from the information display apparatus a signal including wireless network information, for analyzing the received signal, and for obtaining the wireless network information before a wireless connection to the information display apparatus is established, the wireless network information being used for establishing the wireless connection between the information display apparatus and the information terminal apparatus;
a first signal generation part for generating a signal including the information to be displayed on the display device and for transmitting the signal to the information display apparatus; and
a network connection part for issuing a wireless connection request to the information display apparatus by using the wireless network information.

2. The information terminal apparatus according to claim 1, wherein before the wireless connection to the information display apparatus is established, the information terminal apparatus transmits the signal to the information display apparatus by using an SSID beacon and receives the signal from the information display apparatus by using an SSID beacon.

3. The information terminal apparatus according to claim 2, wherein in a process for establishing the wireless connection to the information display apparatus, the first signal generation part causes the SSID beacon to include a state of progress of the wireless connection and transmits the SSID beacon to the information display apparatus.

4. The information terminal apparatus according to claim 2, wherein when the first signal generation part determines that the wireless connection to the information display apparatus has failed, the first signal generation part causes the SSID beacon to include information indicating that the wireless connection has failed and transmits the SSID to the information display apparatus.

5. The information terminal apparatus according to claim 3, wherein the information terminal apparatus further comprises:
a connection state detection part for detecting a failure of the wireless connection;
a cause identification part for identifying a cause of the failure of the wireless connection based on the state of progress of the wireless connection; and
a solution presentation part for presenting a solution to the cause of the failure of the wireless connection.

6. The information terminal apparatus according to claim 1, wherein when a multiple of the information display apparatuses to which wireless connections are conducted are present and a multiple of the display devices are present,
the first signal generation part generates signals including information to be displayed on the multiple display devices, transmits the signals to the multiple information display apparatuses, and causes the multiple display devices to display the information pertinent to the wireless connections to the multiple information display apparatuses.

7. An information display apparatus operable to cause a display device to display information received from an information terminal apparatus, the information display apparatus comprising:
a network generation part for generating wireless network information and for processing a wireless connection request issued from the information terminal apparatus before a wireless connection to the information terminal apparatus is established, the wireless network information being used for establishing the wireless connection between the information display apparatus and the information terminal apparatus;
a second signal generation part for generating a signal including the wireless network information and for transmitting the signal to surroundings;
a second signal analysis part for receiving a signal from the information terminal apparatus, for analyzing the received signal, and for obtaining the information to be displayed on the display device; and
a display part for causing the display device to display the obtained information.

8. The information display apparatus according to claim 7, wherein before the wireless connection to the information terminal apparatus is established, the information display apparatus transmits the signal to the information terminal apparatus by using an SSID beacon and receives the signal from the information terminal apparatus by using an SSID beacon.

9. The information display apparatus according to claim 8, wherein in a process for establishing the wireless connection to the information terminal apparatus, the second signal analysis part receives from the information terminal apparatus the SSID beacon including a state of progress of the wireless connection, and
the display part causes the display device to display the received state of progress of the wireless connection.

10. The information display apparatus according to claim 9, wherein when the state of progress of the wireless connection, received from the information terminal apparatus, does not change for a predetermined period of time, the second signal analysis part determines that the wireless connection has failed, and
the display part causes the display device to display that the wireless connection has failed.

11. The information display apparatus according to claim 8, wherein
the second signal analysis part receives from the information terminal apparatus a signal including a solution to a cause of a failure of the wireless connection, and
the display part causes the display device to display the received solution to the cause of the failure of the wireless connection.

12. The information display apparatus according to claim 7, wherein when the multiple information terminal apparatuses to which wireless connections are conducted are present,
the second signal analysis part receives, from the multiple information terminal apparatuses, information pertinent to the wireless connections, and
the display part causes the display device to display the information pertinent to the wireless connections of the multiple information terminal apparatuses.

13. The information display apparatus according to claim 7, wherein the information display apparatus is a projector displaying the information on the display device.

14. A wireless network system in which an information terminal apparatus causes a display device to display information via an information display apparatus, the wireless network system comprising the information terminal apparatus and the information display apparatus, wherein
the information terminal apparatus includes:
a first signal analysis part for receiving from the information display apparatus a signal including wireless network information, for analyzing the received signal, and for obtaining the wireless network information before a wireless connection to the information display apparatus is established, the wireless network information being used for establishing the wireless connection between the information display apparatus and the information terminal apparatus;
a first signal generation part for generating a signal including the information to be displayed on the display device and for transmitting the signal to the information display apparatus; and
a network connection part for issuing a wireless connection request to the information display apparatus by using the wireless network information, and
the information display apparatus includes:
a network generation part for generating the wireless network information and for processing the wireless connection request issued from the information terminal apparatus before the wireless connection to the information terminal apparatus is established;
a second signal generation part for generating a signal including the wireless network information and for transmitting the signal to surroundings;
a second signal analysis part for receiving the signal from the information terminal apparatus, for analyzing the received signal, and for obtaining the information to be displayed on the display device; and
a display part for causing the display device to display the obtained information.

15. A method implemented by an information terminal apparatus operable to cause a display device to display information via an information display apparatus, the method comprising the steps of:
receiving from the information display apparatus a signal including wireless network information used for establishing a wireless connection between the information display apparatus and the information terminal apparatus before the wireless connection to the information display apparatus is established;
analyzing the received signal and obtaining the wireless network information;
generating a signal including the information to be displayed on the display device and transmitting the signal to the information display apparatus; and
issuing a wireless connection request to the information display apparatus by using the wireless network information.

16. A method implemented by an information display apparatus operable to cause a display device to display information received from an information terminal apparatus, the method comprising the steps of:
generating wireless network information used for establishing a wireless connection between the information display apparatus and the information terminal apparatus, before the wireless connection to the information terminal apparatus is established;
generating a signal including the wireless network information and transmitting the signal to surroundings;
receiving the signal from the information terminal apparatus;
analyzing the signal received from the information terminal apparatus and obtaining the information to be displayed on the display device;
causing the display device to display the obtained information; and
processing a wireless connection request issued from the information terminal apparatus.

17. A non-transitory computer-readable storage medium having stored therein a program executed by an information terminal apparatus operable to cause a display device to display information via an information display apparatus, the program comprising the steps of:
receiving from the information display apparatus a signal including wireless network information used for establishing a wireless connection between the information display apparatus and the information terminal apparatus, before the wireless connection to the information display apparatus is established;
analyzing the signal received from the information display apparatus and obtaining the wireless network information;
generating a signal including the information to be displayed on the display device and transmitting the signal to the information display apparatus; and
issuing a wireless connection request to the information display apparatus by using the wireless network information.

18. A non-transitory computer-readable storage medium having stored therein a program executed by an information display apparatus operable to cause a display device to display information received from an information terminal apparatus, the program comprising the steps of:
generating wireless network information used for establishing a wireless connection between the information display apparatus and the information terminal apparatus, before the wireless connection to the information terminal apparatus is established;
generating a signal including the wireless network information and transmitting the signal to surroundings;
receiving a signal from the information terminal apparatus;
analyzing the signal received from the information terminal apparatus and obtaining the information to be displayed on the display device;
causing the display device to display the obtained information; and
processing a wireless connection request issued from the information terminal apparatus.
